(19) United States
(12) Patent Application Publication
(10) Pub. No.: US 2013/0168381 A1
(43) Pub. Date: Jul. 4, 2013

(54) HEAT GENERATING ARTICLE AND METHOD OF MANUFACTURING SAME

(71) Applicants: Reena Srivastava, Lee's Summit, MO (US); Jamison William Janawitz, Overland Park, KS (US); Taher Mousa Abujoudeh, Khobar (SA); Vishal Bansal, Overland Park, KS (US); Martin Gregory Hatfield, Odessa, MO (US); Gaston Justice MacMillan, El Cerrito, CA (US)

(72) Inventors: Reena Srivastava, Lee's Summit, MO (US); Jamison William Janawitz, Overland Park, KS (US); Taher Mousa Abujoudeh, Khobar (SA); Vishal Bansal, Overland Park, KS (US); Martin Gregory Hatfield, Odessa, MO (US); Gaston Justice MacMillan, El Cerrito, CA (US)

(21) Appl. No.: 13/342,346

(22) Filed: Jan. 3, 2012

(51) Int. Cl. H05B 3/34; H01R 43/00

(52) U.S. Cl. 219/529; 29/825

(57) ABSTRACT

A method of manufacturing an article is provided. The method includes applying a coating onto a fabric layer, wherein the coating absorbs solar energy and converts solar energy into electrical energy. Moreover, the method includes applying a membrane onto the fabric layer. An insulation layer is applied onto the membrane. Further, a heat conductive coating is applied onto at least one of the membrane and the insulation layer.

### BACKGROUND OF THE INVENTION

The field of the invention relates generally to an article and, more particularly, to an article that uses a plurality of layers to selectively generate heat.

At least some known heat generating systems use articles, such as multi-layered laminates. For example, at least some known solar energy systems use solar panel arrays that include a plurality of solar panels. At least some known solar panels include multi-layered laminates that form a plurality of solar cells, such as a plurality of photovoltaic cells. During use, the solar cells absorb solar energy that may be converted into electrical energy. Such known solar energy systems use the electrical energy to generate heat.

Moreover, such known solar energy systems are used to provide heat in conjunction with buildings and other types of dwellings. More specifically, known solar panel arrays can be coupled to a building, such as the rooftop of a building. Although such systems may be used to provide heat to a variety of different buildings, such known systems are not fabricated from flexible materials that can be used in various ways, such as being worn as a garment to provide heat to a user.

### BRIEF DESCRIPTION OF THE INVENTION

In one embodiment, a method of manufacturing an article is provided. The method includes applying a coating onto a fabric layer, wherein the coating absorbs solar energy and converts solar energy into electrical energy. Moreover, the method includes applying a membrane onto the fabric layer. An insulation layer is applied onto the membrane. Further, a heat conductive coating is applied onto at least one of the membrane and the insulation layer.

In another embodiment, an article that selectively generates heat is provided. The article includes a fabric layer and a coating that is applied onto the fabric layer. The coating absorbs solar energy and converts solar energy into electrical energy. Moreover, the article includes a membrane that is applied onto the fabric layer and an insulation layer that is applied onto the membrane. The article also includes a heat conductive coating that is applied onto at least one of the membrane and the insulation layer. The heat conductive coating receives electrical energy and converts electrical energy into thermal energy.

In another embodiment, an apparatus that selectively generates heat is provided. The apparatus includes at least one substrate layer, an article configured to selectively generate heat overlaying the substrate layer, and an energy storage device that is coupled to the article. The article includes a fabric layer and a coating that is applied onto the fabric layer. The coating absorbs solar energy and converts solar energy into electrical energy. Moreover, the article includes a membrane that is applied onto the fabric layer and an insulation layer that is applied onto the membrane. The article also includes a heat conductive coating that is applied onto at least one of the membrane and the heat conductive coating. The heat conductive coating receives electrical energy and converts electrical energy into thermal energy.

### BRIEF DESCRIPTION OF THE DRAWINGS

FIG. 1 is a schematic cross-sectional view of a portion of an exemplary article that selectively generates heat;

FIG. 2 is an exploded schematic cross-sectional view of a portion of an alternative embodiment of the article shown in FIG. 1;

FIG. 3 is a schematic cross-sectional view of a portion of an alternative embodiment of an exemplary article that selectively generates heat;

FIG. 4 is a schematic view of an exemplary apparatus that selectively generates heat and is formed from the article shown in FIG. 1; and

FIG. 5 is an exemplary method of manufacturing the article shown in FIG. 1.

### DETAILED DESCRIPTION OF THE INVENTION

The exemplary methods, apparatus, and systems described herein overcome disadvantages associated with known heat generating systems and devices. The embodiments described herein provide an article that uses a plurality of layers to selectively generate heat. The article includes a fabric layer enabling the article to be flexible such that the article can be used in various ways, such as being fabricated into a garment such that a wearer can be warm.

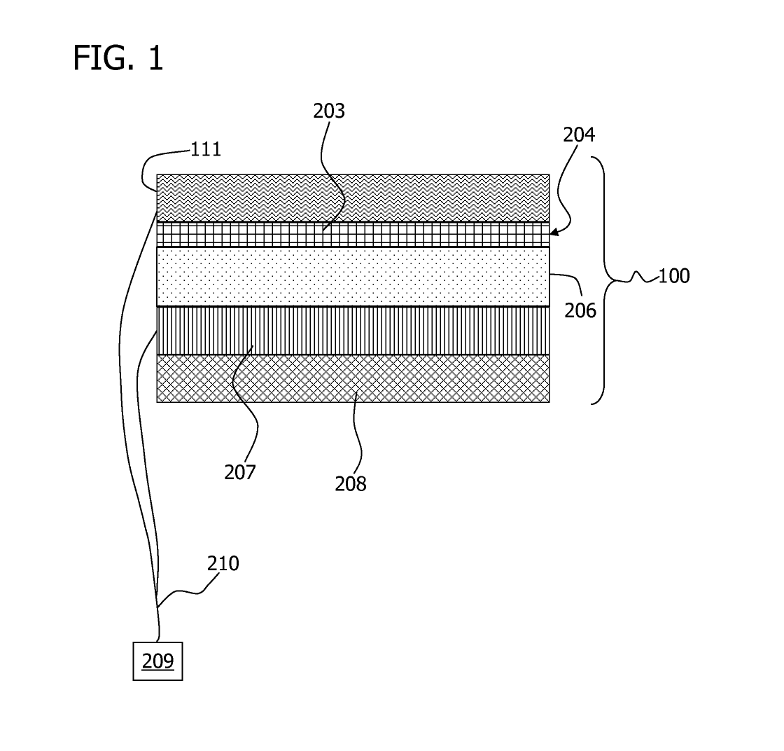

FIG. 1 is a schematic cross-sectional view of a portion of an article 100 that selectively generates heat. In the exemplary embodiment, article 100 includes a fabric layer 111 and a coating 203 that is applied onto the fabric layer. In the exemplary embodiment, coating 203 is applied onto fabric layer 111 via a spray process that facilitates substantially evenly distributing a layer of coating 203 across fabric layer 111. Alternatively, coating 203 may be applied or impregnated onto fabric layer 111 using any method known in the art that enables article 100 to function as described herein.

In the exemplary embodiment, coating 203 includes a plurality of solar cells 204, such as a plurality of thin film solar cells and/or a plurality of photovoltaic cells. Moreover, in the exemplary embodiment, each solar cell 204 is fabricated from a material containing electrons, such as a monocrystalline silicon material. Solar cells 204 are interconnected via an electrically conductive connector (not shown), such as a metallic wire.

Moreover, article 100 includes a membrane 206 that is applied onto fabric layer 111. More specifically, in the exemplary embodiment, membrane 206 is applied onto coating 203 on fabric layer 111. Article 100 also includes an insulation layer 207 that is applied onto membrane 206. In the exemplary embodiment, insulation layer 207 is applied to membrane 206 with an adhesive, such as fabric adhesive or glue. Alternatively, insulation layer 207 may be applied to membrane 206 using any manner known in the art that enables article 100 to function as described herein. Furthermore, in the exemplary embodiment, insulation layer 207 is formed from a non-woven material that enables heat to be retained within layer 207, such as an acrylic material. Alternatively, insulation layer 207 may be formed from any material that enables heat to be retained within and that enables article 100 to function as described herein.

Article 100 also includes a heat conductive coating 208 that is applied onto at least one of membrane 206 and insulation layer 207. In the exemplary embodiment, heat conductive coating 208 is applied across insulation layer 207 via a spray process that facilitates substantially evenly distributing a layer of coating 208 across layer 207. Alternatively, heat conductive coating 208 may be applied across layer 207 or impregnated thereon using any method known in the art that enables article 100 to function as described herein.

In the exemplary embodiment, membrane 206 is a porous membrane that is waterproof and breathable. More specifically, in the exemplary embodiment, membrane 206 is formed from an oleophobic expanded polytetrafluoroethylene (ePTFE) material. Alternatively, membrane 206 may be formed from any type of porous material, such as, but limited to, fluoropolymers, sulfonated polymers, polyamides, polyimides, and cellulosic polymers. Alternatively, membrane 206 may be a formed from a nonporous material or any combination of a porous and nonporous material that enables article 100 to function as described herein.

In the exemplary embodiment, heat conductive coating 208 is a metallic coating. Alternatively, heat conductive coating 208 may be a metal alloy coating. Moreover, heat conductive coating 208 may be formed from any material that enables article 100 to function as described herein.

Moreover, in the exemplary embodiment, a sensing device (not shown) is incorporated into article 100. The sensing device detects when the ambient temperature drops below a pre-determined temperature.

In the exemplary embodiment, an energy storage device 209 is coupled to article 100. More specifically, energy storage device 209 is coupled to fabric layer 111 and to insulation layer 207 via a connector 210. In the exemplary embodiment, energy storage device 209 is a battery that includes at least one galvanic cell (not shown in FIG. 1). Alternatively, energy storage device 209 can be any component or device that enables article 100 and/or energy storage device 209 to function as described herein.

Moreover, in the exemplary embodiment, connector 210 is fabricated from a metallic wire. Alternatively, connector 210 may be fabricated from any other substance or compound that enables connector 210 and article 100 to function as described herein.

During operation, solar energy directed towards article 100 is absorbed by coating 203 extending across fabric layer 111. Solar cells 204 in coating 203 convert the absorbed solar energy into electrical energy via the electrons present in each solar cell 204. The electrical energy is then transmitted from solar cells 204 to energy storage device 209 via connector 210.

Energy storage device 209 stores the electrical energy until heat is needed for article 100. More specifically, the sensing device detects when the ambient temperature drops below a predetermined temperature range. If the ambient temperature drops below the predetermined temperature range, then the sensing device transmits a signal to energy storage device 209.

Energy storage device 209 then transmits electrical energy to heat conductive coating 208 on insulation layer 207 via connector 210. As the electrical energy flows across heat conductive coating 208, the electrical energy converts to thermal energy. The thermal energy is then indirectly transferred as heat from heat conductive coating 208 to insulation layer 207. The insulation layer 207 retains the heat within layer 207 and/or article 100. Moreover, insulation layer 207 retains stagnant air within layer 207. Accordingly, the retained heat within layer 207 is transferred to the stagnant air and facilitates heat insulation within layer 207 and/or article 100. While the exemplary embodiment is shown to generate heat, the energy generated can also be used as a power source. For example, in an alternative embodiment, the energy generated can be used to charge or recharge a battery or power an electrical device, such as a digital audio player (i.e., MP3 player).

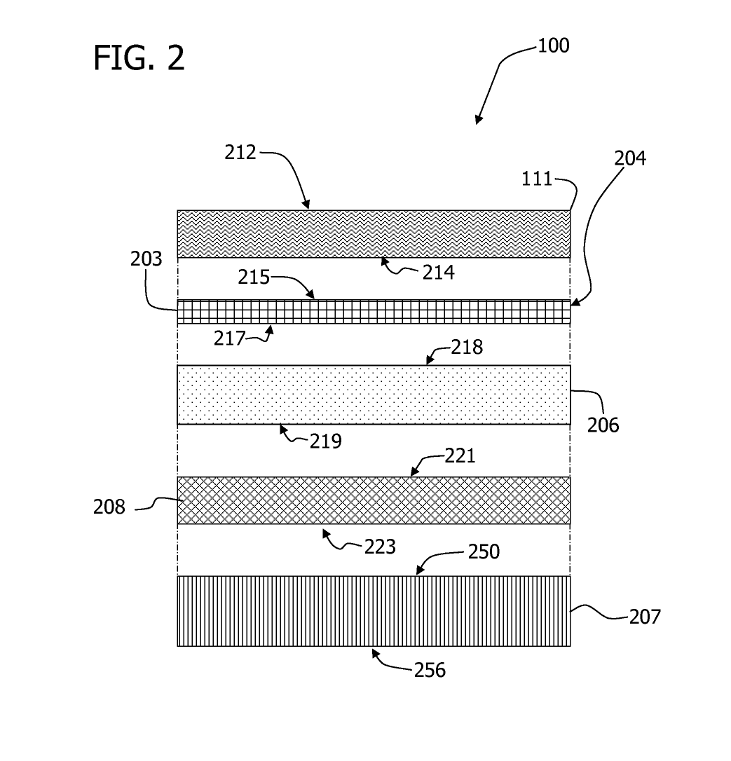

FIG. 2 is an exploded schematic cross-sectional view of a portion of an alternative embodiment of article 100. In the exemplary embodiment, fabric layer 111 has an upper surface 212 and a lower surface 214. Similarly, coating 203 has an upper surface 215 and a lower surface 217. In the exemplary embodiment, fabric layer lower surface 214 is against coating upper surface 215.

Moreover, in the exemplary embodiment, heat conductive coating 208 is applied across membrane 206 via a spray process that facilitates substantially evenly distributing a layer of coating 208 across membrane 206. Alternatively, heat conductive coating 208 may be applied across membrane 206 or impregnated thereon using any method known in the art that enables article 100 to function as described herein.

Moreover, in the exemplary embodiment, membrane 206 has an upper surface 218 and a lower surface 219. Similarly, heat conductive coating 208 has an upper surface 221 and a lower surface 223. In the exemplary embodiment, membrane lower surface 219 is against heat conductive coating upper surface 221. Moreover, in the exemplary embodiment, coating lower surface 217 is against membrane upper surface 218.

Moreover, in the exemplary embodiment, insulation layer 207 has an upper surface 250 and a lower surface 256, and insulation layer 207 is applied onto membrane 206. More specifically, layer 207 is applied onto heat conductive coating 208 on membrane 206. In the exemplary embodiment, insulation layer upper surface 250 is against heat conductive coating lower surface 223.

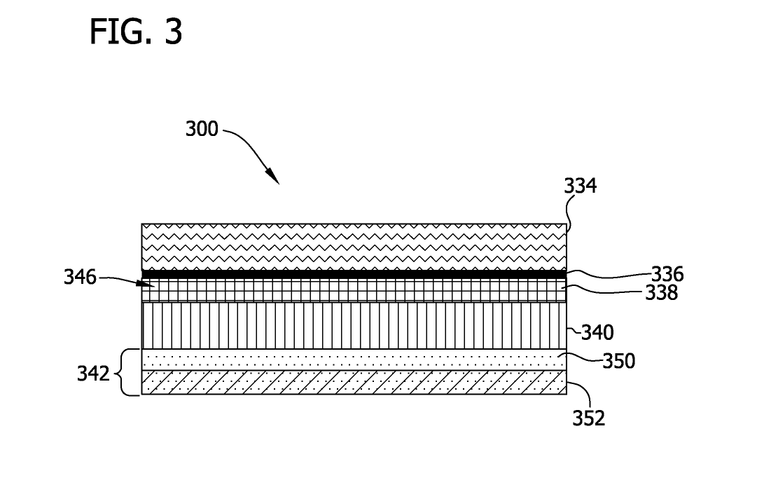

FIG. 3 is a schematic cross-sectional view of a portion of an alternative embodiment of an exemplary article 300 that selectively generates heat. In the exemplary embodiment, article 300 includes a fabric layer 334, a protective layer 336 that is applied onto the fabric layer, and a coating 338 that is applied onto protective layer 336. In the exemplary embodiment, protective layer 336 is applied to fabric layer 334 with an adhesive such as a fabric adhesive or glue. Alternatively, protective layer 336 may be applied to fabric layer 334 using any manner known in the art that enables article 300 to function as described herein. Furthermore, in the exemplary embodiment, protective layer 336 is a thin layer formed from a material that is wind and/or water resistant, such as polyester.

In the exemplary embodiment, coating 338 is applied onto protective layer 336 via a spray process that facilitates substantially evenly distributing a layer of coating 338 across protective layer 336. Alternatively, coating 338 may be applied or impregnated onto protective layer 336 using any method known in the art that enables article 300 to function as described herein.

In the exemplary embodiment, coating 338 includes a plurality of solar cells 346, such as a plurality of thin film solar cells and/or a plurality of photovoltaic cells. Moreover, in the exemplary embodiment, each solar cell 346 is fabricated from a material containing electrons, such as a monocrystalline silicon material. Solar cells 346 are interconnected via an electrically conductive connector (not shown), such as a metallic wire.

Moreover, article 300 includes a heat conductive coating 340 applied onto a membrane 342. In the exemplary embodiment, coating 340 is applied across membrane 342 via a spray process that facilitates substantially evenly distributing a layer of coating 340 across membrane 342. Alternatively, coating 340 may be applied across membrane 342 or impregnated thereon using any method known in the art that enables article 300 to function as described herein.

In the exemplary embodiment, heat conductive coating 340 is a metallic coating. Alternatively, heat conductive coating 340 may be a metal alloy coating. Moreover, heat conductive coating 340 may be formed from any material that enables article 300 to function as described herein.

Moreover, in the exemplary embodiment, membrane 342 is a bi-component membrane 342 having a first layer 350 and a second layer 352. In the exemplary embodiment, first layer 350 of membrane 342 is porous. More specifically, in the exemplary embodiment, first layer 350 is formed from an ePTFE material. Alternatively, first layer 350 may be formed from any type of porous material, such as, but limited to, fluoropolymers, sulfonated polymers, polyamides, polyimides, and cellulosic polymers. Moreover, in the exemplary embodiment, second layer 352 of membrane 342 is nonporous and is formed from a nonporous material.

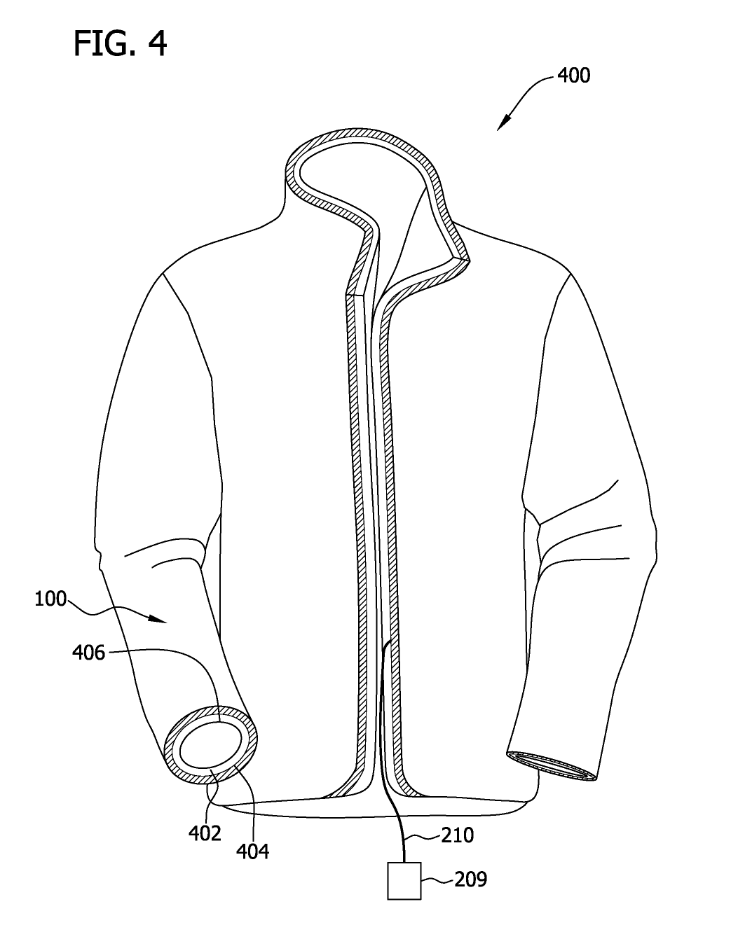

FIG. 4 is a schematic view of an exemplary garment that is an apparatus 400 that selectively generates heat and is formed from article 100. While FIG. 4 illustrates an exemplary garment, it should be noted that apparatus 400 as described herein is not limited to any one particular embodiment. Notably, one of ordinary skill in the art will appreciate that the present invention may be used in any suitable configuration that enables apparatus 400 to function as described herein.

In the exemplary embodiment, apparatus 400 includes at least one substrate layer 402. In the exemplary embodiment, substrate layer 402 is formed from a fabric material, such as a knit liner fabric. Alternatively, substrate layer 402 can be formed from any medium and/or material to enable apparatus 400 to function as described herein. In the exemplary embodiment, substrate layer 402 is formed with an upper surface 404 and a lower surface 406.

Moreover, apparatus 400 includes article 100 overlaying and extending across substrate layer 402. More specifically, article 100 is formed with and extends across upper surface 404 of substrate layer 402. In the exemplary embodiment, article 100 is applied to substrate layer 402 with an adhesive, such as a fabric adhesive or glue. Alternatively, article can be applied to substrate layer 402 using any manner known in the art that enables apparatus 400 to function as described herein. Moreover, apparatus 400 includes energy storage device 209 coupled to article 100.

During operation, solar energy directed towards apparatus 400 is absorbed by coating 203 (shown in FIGS. 1 and 2) extending across fabric layer 111 (shown in FIGS. 1 and 2) of article 100. Solar cells 204 (shown in FIGS. 1 and 2) in coating 203 (shown in FIGS. 1 and 2) convert the absorbed solar energy into electrical energy via the electrons present in each solar cell 204. The electrical energy is then transmitted from solar cells 204 to energy storage device 209 via connector 210.

Energy storage device 209 stores the electrical energy until heat is needed for apparatus 400. More specifically, the sensing device (not shown) detects when the ambient temperature drops below a predetermined temperature range. If the ambient temperature drops below the predetermined temperature range, then the sensing device transmits a signal to energy storage device 209.

Energy storage device 209 then transmits electrical energy to heat conductive coating 208 (shown in FIGS. 1 and 2) via connector 210. As the electrical energy flows across heat conductive coating 208, the electrical energy converts to thermal energy. The thermal energy is then indirectly transferred as heat from heat conductive coating 208 to insulation layer 207 (shown in FIGS. 1 and 2). The insulation layer 207 retains the heat within layer 207 and/or article 100. Moreover, insulation layer 207 retains stagnant air within layer 207. Accordingly, the retained heat within layer 207 is transferred to the stagnant air and facilitates heat insulation within layer 207 and/or article 100, and heat is transferred to a wearer of apparatus 400.

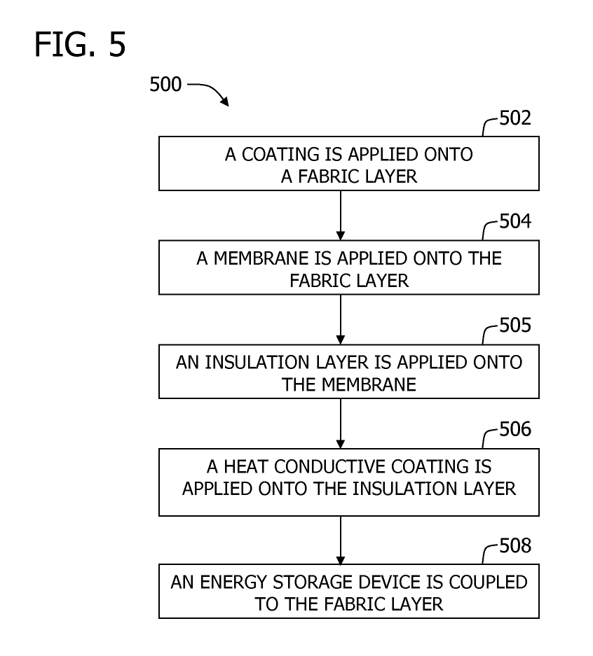

FIG. 5 is an exemplary method 500 of manufacturing an article that selectively generates heat, such as article 100 (shown in FIG. 1). In the exemplary embodiment, a coating 203 (shown in FIGS. 1 and 2) is applied 502 onto a fabric layer 111 (shown in FIGS. 1 and 2), wherein coating 203 absorbs solar energy and converts solar energy into electrical energy. A membrane 206 (shown in FIGS. 1 and 2) is applied 504 onto fabric layer 111. An insulation layer 207 (shown in FIGS. 1 and 2) is applied 505 onto membrane 206. Moreover, a heat conductive coating 208 (shown in FIGS. 1 and 2) is applied 506 onto insulation layer 207. Heat conductive coating 208 receives electrical energy and converts electrical energy into thermal energy. An energy storage device 209 (shown in FIGS. 1 and 4) is then coupled 508 to fabric layer 111.

The methods and components for an article that selectively generates heat as described herein facilitate a flexible medium for the absorption and storage of energy to be used as a heat source when needed. More specifically, the embodiments described herein provide an article that has a plurality of layers, including a fabric layer. Such layers enable the article to be flexible, such that the article can be used in various ways, such as being fabricated into a garment in order for a wearer to stay warm.

Exemplary embodiments of an article that selectively generates heat are described above in detail. The methods, apparatus, and systems are not limited to the specific embodiments described herein nor to the specific illustrated energy harvesting apparatus. While the invention has been described in terms of various specific embodiments, those skilled in the art will recognize that the invention can be practiced with modification within the spirit and scope of the claims.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of manufacturing an article, said method comprising:
applying a coating onto a fabric layer, wherein the coating absorbs solar energy and converts solar energy into electrical energy;
applying a membrane onto the fabric layer;
applying an insulation layer onto the membrane; and
applying a heat conductive coating onto at least one of the membrane and the insulation layer.

2. A method in accordance with claim 1 further comprising coupling an energy storage device to the fabric layer.

3. A method in accordance with claim 2 further comprising:
configuring the energy storage device to receive electrical energy from the coating on the fabric layer; and
configuring the energy storage device to transmit electrical energy to the heat conductive coating.

4. A method in accordance with claim 1, wherein said applying a coating onto the fabric layer further comprises applying the coating having a plurality of solar cells onto the fabric layer.

5. A method in accordance with claim 1, wherein said applying a heat conductive coating onto the membrane further comprises applying at least one of a metallic coating and a metal alloy coating onto the membrane.

6. A method in accordance with claim 1, wherein said applying a membrane onto the fabric layer further comprises applying a porous membrane onto the fabric layer.

7. A method in accordance with claim 1, wherein said applying a membrane onto the fabric layer further comprises applying an oleophobic expanded polytetrafluoroethylene (ePTFE) membrane onto the fabric layer.

8. An article that selectively generates heat comprising:
a fabric layer;
a coating applied onto said fabric layer, said coating absorbs solar energy and converts solar energy into electrical energy;
a membrane applied onto said fabric layer;
an insulation layer applied onto said membrane; and
a heat conductive coating applied onto at least one of said membrane and said insulation layer, said heat conductive coating receives electrical energy and converts electrical energy into thermal energy.

9. An article in accordance with claim 8 further comprising an energy storage device coupled to said fabric layer, wherein said energy storage device receives electrical energy from said coating on said fabric layer and said energy storage device transmits electrical energy to said heat conductive coating.

10. An article in accordance with claim 8, wherein said coating comprises a plurality of solar cells.

11. An article in accordance with claim 8, wherein said coating comprises a plurality of photovoltaic cells.

12. An article in accordance with claim 8, wherein said heat conductive coating comprises at least one of a metallic coating and a metal alloy coating.

13. An article in accordance with claim 8, wherein said membrane comprises a bi-component membrane.

14. An article in accordance with claim 8, wherein said membrane comprises a porous membrane, wherein said porous membrane is waterproof and breathable.

15. An article in accordance with claim 8, wherein said membrane comprises an oleophobic expanded polytetrafluoroethylene (ePTFE) membrane.

16. An apparatus that selectively generates heat comprising:
at least one substrate layer;
an article configured to selectively generate heat overlaying said at least one substrate layer, wherein said article comprises:
a fabric layer;
a coating applied onto said fabric layer, said coating absorbs solar energy and converts solar energy into electrical energy;
a membrane applied onto said fabric layer;
an insulation layer applied onto said membrane;
a heat conductive coating applied onto at least one of said membrane and said insulation layer, said heat conductive coating receives electrical energy and converts electrical energy into thermal energy; and
an energy storage device coupled to said article.

17. An apparatus in accordance with claim 16, wherein said coating comprises a plurality of solar cells.

18. An apparatus in accordance with claim 16, wherein said article further comprises a protective layer applied onto said fabric layer.

19. An apparatus in accordance with claim 16, wherein said heat conductive coating comprises at least one of a metallic coating and a metal alloy coating.

20. An apparatus in accordance with claim 16, wherein said membrane comprises an oleophobic expanded polytetrafluoroethylene (ePTFE) membrane.
